(19) United States
(12) Patent Application Publication
(10) Pub. No.: US 2008/0040131 A1
(43) Pub. Date: Feb. 14, 2008

(54) Interpersonal pursuit method

(76) Inventor: Erik von Markovik, Las Vegas, NV (US)

Correspondence Address: WEISS & MOY PC, 4204 NORTH BROWN AVENUE, SCOTTSDALE, AZ, 85251, US

(21) Appl. No.: 11/502,049

(22) Filed: Aug. 10, 2006

(51) Int. Cl. G06Q 10/00; G06Q 30/00

(52) U.S. Cl. 705/1

(57) ABSTRACT

An interpersonal pursuit method specifically comprises instructing a male regarding improved methods for pursuing a physical relationship with a female. The method includes instructing males regarding three main steps of establishing attraction, building comfort, and seduction. These steps are executed in sequence. Each of these three main steps includes three constituent steps, which are also preferably executed in sequence. The step of establishing attraction occurs at a meeting location, the step of building comfort begins at a location that is within the meeting location, moves to a separate comfort location, and then moves a second time to a location within the seduction location, and the step of seduction occurs at the seduction location. Preferably, between about four and ten hours, within about seven hours being considered optimal, is allotted for the period from the beginning of the process until its conclusion.

### FIELD OF THE INVENTION

The present invention relates generally to interpersonal pursuit methods that may be utilized by males pursuing females and, more particularly, to an improved interpersonal pursuit method for use by males pursuing females.

### BACKGROUND OF THE INVENTION

A significant percentage of males desire greater success in the pursuit of relationships, including particularly sexual relationships, with members of the opposite sex. This desire is characteristic of, though not exclusive to, men who are in their late teens and early twenties. This period of time is often thought of as a man's primary dating years, when sexual desire and performance may be at their highest levels.

There are myriad guides available to men who seek to become more successful in the pursuit of relationships with women. However, prior art methods fail to fully take into account the social and sexual dynamics that characterize male-female interactions, male and female biological motivators, and other relevant factors, and are therefore insufficient.

A need exists for an improved interpersonal pursuit method that more fully takes into account the social and sexual dynamics that characterize male-female interactions, biological motivators, and that is capable of being taught. The present invention satisfies these needs and provides other, related, advantages.

### SUMMARY OF THE INVENTION

In accordance with an embodiment of the present invention, an interpersonal pursuit method for a male pursuing an intimate relationship with a female is disclosed. The method comprises: instructing a male regarding an interpersonal pursuit method comprising instructing the male how to: build attraction on the part of a target female; establish comfort with the target female; and promptly after conclusion of the step of establishing comfort, seducing the target female and having sexual intercourse with her; wherein the steps of building attraction, establishing comfort, and seducing last between four and ten hours; wherein the step of building attraction occurs at a first location, wherein the step of establishing comfort begins at the first location and continues to a second and than a third location, and wherein the step of seducing the target female occurs at the third location.

In accordance with another embodiment of the present invention, an interpersonal pursuit method for a male pursuing an intimate relationship with a female is disclosed. The method comprises: instructing a male regarding an interpersonal pursuit method comprising instructing the male how to: build attraction on the part of a target female; wherein the step of building attraction comprises the following sub-steps: opening a set and continuing until reaching a social hook point; establishing female to male interest; and establishing male to female interest; establish comfort with the target female; wherein the step of building comfort comprises the following sub-steps: the male engaging in conversation with the target female; the male establishing a connection with the target female; and the male beginning intimate relations with the target female; and promptly after conclusion of the step of establishing comfort, seducing the target female and having sexual intercourse with her; wherein the step of the male seducing the target female comprises the following sub-steps: the male and the target female engaging in foreplay; the male overcoming last minute resistance on the part of the target female to sexual intercourse; and the male and target female engaging in sexual intercourse; wherein the steps of building attraction, establishing comfort, and seducing last between four and ten hours; wherein the step of building attraction occurs at a first location, wherein the step of establishing comfort begins at the first location and continues to a second and than a third location, and wherein the step of seducing the target female occurs at the third location.

In accordance with a further embodiment of the present invention, an interpersonal pursuit method for a male pursuing an intimate relationship with a female is disclosed. The method comprises: An interpersonal pursuit method for a male pursuing an intimate relationship with a female, comprising: instructing a male regarding an interpersonal pursuit method comprising instructing the male how to: build attraction on the part of a target female; wherein the step of building attraction comprises the following sub-steps: opening a set and continuing until reaching a social hook point; including instructing the male to use at least one of negs, disinterested body language, a false time constraint, and entry to the set with another female; establishing female to male interest; including instructing the male to utilize multiple conversational threads; and establishing male to female interest; including instructing the male to engage in at least one of role reversal, screening, intermittent provision of indicators of interest and indicators of disinterest, and compliance testing; establish comfort with the target female; wherein the step of building comfort comprises the following sub-steps: the male engaging in conversation with the target female; the male establishing a connection with the target female; and the male beginning intimate relations with the target female; and promptly after conclusion of the step of establishing comfort, seducing the target female and having sexual intercourse with her; wherein the step of the male seducing the target female comprises the following sub-steps: the male and the target female engaging in foreplay; the male overcoming last minute resistance on the part of the target female to sexual intercourse; and the male and target female engaging in sexual intercourse; wherein the steps of building attraction, establishing comfort, and seducing last between four and ten hours; wherein the step of building attraction occurs at a first location, wherein the step of establishing comfort begins at the first location and continues to a second and than a third location, and wherein the step of seducing the target female occurs at the third location.

### BRIEF DESCRIPTION OF THE DRAWINGS

FIG. 1 is a flow diagram of main steps in performance of a method consistent with an embodiment of the present invention.

FIG. 2 is a flow diagram of main and constituent steps in performance of a method consistent with an embodiment of the present invention.

### DETAILED DESCRIPTION OF THE PREFERRED EMBODIMENTS

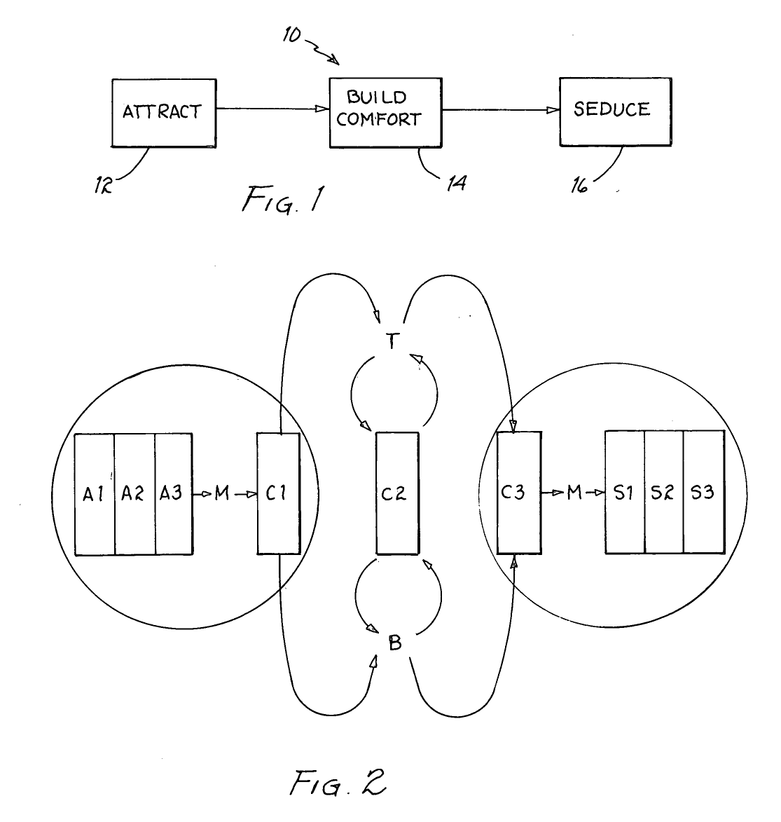

Referring first to FIG. 1, a flow diagram 10 is presented, illustrating three main steps in an interpersonal pursuit method consistent with an embodiment of the present invention. Each block within the diagram 10 is representative of a step in the performance of a method consistent with an embodiment of the present invention. Each constituent step, together with the particular social, sexual and biological dynamics that are relevant thereto, will now be described.

In general, a method consistent with an embodiment of the present invention can be divided into the following three courtship steps or stages: (a) attraction 12; (b) comfort building 14; and (c) seduce 16. (These can also be thought of as the beginning, middle and ending stages, or the pick-up, mid-game and end-game stages, respectively.) The method of the present invention sets forth a series of steps that are designed to permit a male, in pursuant of a sexual relationship with a female, to successfully progress through the three major steps, in a manner that is enjoyable to the male and female and mutually pleasing and satisfactory to both. As discussed in more detail below, it should also be noted that each step/stage is also generally associated with a different physical location.

Turning first to the attraction step, in this stage, the goal is for the male to build attraction in the eyes of the female that he is pursuing. Success in building attraction depends in part on an understanding of those qualities that generally promote attraction on the part of a female for a male. Being biological creatures, women unconsciously tend to be attracted to men who have higher survival and replication values. Intuitively, when seeing a man, a woman will assess his survival and replication values and emotionally perceive the result. As between two men, women will be naturally attracted to the one with the highest value.

Qualities that tend to establish higher value in the eyes of a typical woman include looks, height, health, hygiene and grooming, fashion sense, intelligence, social connectedness, being comfortable, smiling and having a sense of humor, being a leader of men, not being needy, being unaffected, having a strong identity and purpose in life, financial independence, and sexual desirability. All of these are demonstrations of higher value (“DHV's”). In addition, a woman will find a man more attractive if he has already been preselected by other women as sexually attractive to them. Preselection by other women is an important DHV. In contrast, men should avoid demonstrations of lower value (“DLV's”), which include obvious efforts to impress, neediness, and social ineptness.

An explanation for this phenomenon is that, from an emotional perspective, the woman places her survival in greater danger by having sex. Evolutionary speaking, if a man impregnates her, she is dependent upon her emotional pair bond with him to protect her and provide for her during this vulnerable time. If he does not have a pair bond with her, he is likely to move on and she will not have access to his resources. In addition, her reputation for promiscuity will lower her status within her social network, further jeopardizing her survival and replication prospects. Men, by contrast, generally face no such physical or social repercussions for engaging in sex. Sex therefore represents a much greater risk to a woman that it does to a man.

As a consequence of these biological factors, women are generally considerably choosier than men, and it is also much more important to a woman that an emotional pair bond exists before she will engage in sex. Establishing this pair bond is a goal of the steps shown in FIG. 1. The attraction step/stage generally occurs at a first location, referred to as the meeting location.

Addressing now the comfort building step, here the goal is to establish comfort, trust and connection. According to the method of the present invention, it generally takes an average of four to ten cumulative hours of comfort building before a female is ready for seduction. A period of approximately seven hours is preferred. The comfort building stage occurs at a location(s) referred to as the comfort building location(s). Finally, at the sex stage, the goal is to structure an opportunity for seduction. This occurs at a third location, referred to as the sex location.

Generally, it is not possible to alter this three-step sequence, and to still reliably achieve the objectives of the claimed method. Thus, a male who tries to begin with seduction, skipping over the attraction and comfort building stages, is likely to create discomfort on the part of the woman, who is forced to deal with aggressive sexual advances from someone who she doesn't know or trust.

Another error occurs when a male attempts to first build comfort and then proceed to the seduction stage, without first establishing attraction. Absent attraction, a woman may be bored by a male who tries to begin the relationship by building comfort. It is also possible that a woman will see through a nice guy act, and recognize that the male is only being nice in an effort to win her sexual favor.

A third error occurs when a male attempts to go directly from attraction to seduction. By doing so, the man fails to justify a mutual attraction, leading the woman to believe that he is only interested in her looks. In addition, an attempt to seduce a woman before building comfort can turn her off, or make her feel uncomfortable—inducing a kind of buyer's remorse.

A fourth error occurs when a male proceeds through attraction to the comfort building step, but becomes stuck there. In this instance, the woman may fail to perceive the male as having sexual interest in her, and may come to regard him as friendship material (what can be thought of as being stuck in the “friendship zone”), rather than a candidate for a sexual relationship.

As noted above, each step/stage in flow diagram 10 is preferably associated with a different physical location—the meeting location, comfort building location, and the sex location. However, as discussed below, the first substep within the comfort building step is generally associated with the meeting location—although generally within a different portion of the meeting location than is used for the three substeps of the attract stage.

The meeting location will generally be a public gathering, where people self-organize into small groups of usually two to five friends each. Examples of suitable meeting locations include restaurants and busy cafes; pubs, bars and nightclubs; busy stores, malls and outdoor festivals; and parties and get togethers.

Referring now to FIG. 2, in accordance with an embodiment of the method of the present invention, in order to successfully progress through these three stages, it is necessary to progress through a series of sub-steps at each of the three main steps. For reference purposes, the substeps for the attraction stage will be referred to as A1, A2, and A3; the substeps for the comfort stage will be referred to as C1, C2, and C3; and the substeps for the seduction stage will be referred to as S1, S2 and S3.

Treating first the attraction step, substep A1 is the “open.” This occurs when a man approaches a group (sometimes referred to as a “set”) that includes one or more women, and specifically that includes a woman who is the target of the male's attraction. The goal of the open is to reach a social hook point; i.e., the point at which the set decides that they enjoy talking with the male and want to continue talking to him. It is preferred that the male seek to open a set within a very short period of time after spotting the set. Preferably, that period of time is about three seconds. This will add a natural spontaneity and energy to the male's approach, and avoid the appearance that the male is engaged in predatory behavior. In addition, when a male is seen moving around the room, talking with people, and having fun, he will be perceived as having more social proof than a man who is not so engaged, which will make it easier to open and which may even lead a woman to whom the man is attracted to issue a subtle approach invitation, such as the making of eye contact.

During the opening, it is often the case that the woman will use one or more shielding strategies to protect against unwanted male attention. These may include the wearing of a ring, saying she has a boyfriend, surrounding herself with friends, sitting in a place where it is hard to approach her, being rude or using insults, exhibiting negative body language, not making eye contact, showing disinterest, being bubbly and wanting to dance, not showing any sense of humor, and/or being defensive. During the opening substep, the male will want to overcome the woman's protective shield.

There are several methods for overcoming the woman's protective shield. Primarily, the goal will be to indicate disinterest, which will cause her to believe that the man is not seeking to seduce her. These may include one or more of the following: saying things that an interested man would never say (sometimes referred to as “negs”), exhibiting disinterested body language, creating false time constraints, and/or entering the set with another woman. All of these tactics demonstrate a lack of neediness and a willingness to walk, and thus show higher value to the target woman.

During the open, the male preferably will utilize canned material that conveys personality and/or value to the target female. This material should be delivered with a high level of expressiveness, at an energy level that is higher than that of the set, with a deep and powerful voice, slowly and clearly and with plenty of pauses, and loudly. Examples of suitable openers may include the seeking of the set's opinion on an issue (e.g., “Would you date someone who is still friends with his ex-girlfriend?”; “I have two colognes on my wrist and I want to see which one you like better”; “Who lies more, men or women?”; etc.). The canned material should be interesting, should convey personality, and should be congruent with the male's actual personality.

Proper body language during the opener is important. At this stage, the male should not face the set with his body. While the male's head may be turned toward the set, the rest of his body should not be. While the male should turn toward the group when the female turns her body to face him, he should still lean back during the encounter. These physical tactics give greater power to the male and demonstrate higher value and a lack of neediness.

The issue of body language can have special relevance where the set is seated or moving. With a seated set, the male should sit as well. With a moving set, a male should avoid being seen as chasing after the set. Again, in both instances, the goals are to avoid the appearance of chasing and also to demonstrate higher value.

As noted above, one method for overcoming a protective shield during the opener is the use of false time constraints. Shortly after beginning the opener, the male may say something that indicates that he will need to leave shortly—e.g., “I've only got a minute, so I've got to tell you about . . . ” A false time constraint can also be conveyed through body language, such as by rocking the body in a manner that makes it appear that the male is just leaving. A false time constraint can create in the woman a fear of loss.

The opening, referred to as subset A1, ends when the male reaches the social hook point. The social hook point is the moment when the set ceases to wonder when the male will leave, and instead hopes that he will stay.

The second substep during the attraction step, A2, is one in which female to male interest is established. Initially, if not done already, the male should identify one woman within the set as his target. The male will continue to demonstrate higher value to the set as a whole, using the techniques described above. In addition, the male will use one or more verbal expressions of apparent disinterest, referred to as “negs.” Negs are playful verbal statements or gestures (e.g., blowing one's nose) that are teasing, playful, or mildly negative, and thus are of a type that an interested male would typically not make The following are examples:

“Nice nails, are they real?”

“You can dress her up, but you can't take her anywhere”

“You don't get out much, do you?”

“I don't think we should get to know each other—you are just too much of a nice girl for me”

“That's a nice hairstyle—is that your real hair?”

“I just noticed—your nose moves when you speak”

Hinting that the target has a booger, eye crusties, a sweaty palm, or that she has just spit on the male

A neg can make the target feel embarrassed and vulnerable, and can instill a powerful desire to win approval and validation. When this occurs, and where there is attraction, a woman will respond with one or more indicators of interest (“IOI's”). Examples of IOI's can include the woman: initiating conversation when the male stops talking, giggling, touching the male, looking back and glancing at the male repeatedly every minute or so, tossing her hair or playing with her hair while talking with the male, holding eye contact, smiling, standing nearby, interrupting the male's conversation from nearby, laughing at something the male says, brushing against the male, asks for the male's age and/or name, compliments the male, uses nicknames for the male, and so on. The most important IOI's are when the female laughs while talking with the male, reinitiates conversation when the male stops talking, touching the male, and trying to get rapport and build comfort with the male.

Conversely, during the attract step, women will sometimes give indicators of disinterest (“IOD's”). These include the female avoiding eye contact, pretending that she didn't hear what the male said, not contributing to the conversation, getting impatient easily, walking or looking away, leaning away, turning her back, talking to someone else, being non-responsive, and not moving with the male. A primary goal in the attract phase, when encountering an IOD, is to turn these into IOI's. This may be accomplished through being indirect and not needy, demonstrations of higher value, and the use of negs.

During A2, the male will generally need to carry most of the responsibility for maintaining conversation. As noted above, the male may use canned material for this purpose. The male preferably will utilize multiple different conversational threads, rather than just staying with one particular conversational thread. As necessary, for example because of an interruption, because it makes the target bored or sad, or the like, the male should be prepared to cut a particular conversational thread and move on to another one. The male may wish to tell one or more interesting stories, preferably leaving some unanswered questions so that members of the set will ask questions when the story is over. Preferably, the story reveals positive personality traits about the storyteller.

Also during A2, the male may wish to utilize an item of property, such as a hat or some pictures, that he can give to the target to wear or hold, to prevent her from leaving the group. Such an item can be referred to as a “lock-in prop,” since it locks the target into the group.

During A1 and A2, a male may want to use a male friend, referred to as a “wing,” to assist in this process. The purpose of the wing is to help the male attract his target. The wing may occupy non-target females within the set. The wing should create a good impression, which will establish that the male must have high standards because he hangs out with such a great guy. The male should treat the wing with respect and courtesy, turning to face him when he enters the set and taking the wing's side in conversation. The wing can also tell the set about one or more of male's accomplishments—establishing the male's higher value without the male coming across as bragging.

The next sub-step of the attract step is A3, where male to female interest is established. During this phase, the female is induced to work for the male's affections, the male rewards her with IOI's, and the cycle repeats itself.

During this sub-step, a number of things may occur during the interaction between the male and target female. The male will want to establish strength and control what may be referred to as a strong “frame.” On the other hand, the woman may try to get the male to jump through one or more hoops, in order to impose her frame over his. For example, the woman may give a fake IOI to see if the male will start chasing her, may bait the male into showing off, give a fake IOD to see if the male gets worried and reacts, may try to get the male to buy her a drink, etc. In this fashion, a woman tries to assert her feminine power. However, when the male jumps through the hoop, the female will lose attraction for the male, and therefore it is important for the male to be careful to recognize hoops when he sees them, and to avoid jumping through them too early and in a manner that will cause a loss of attraction.

Suitable responses to female hoops can be the putting up by the male of a hoop in response (e.g., Female—“why are you talking to me?” Male—“do you always wear your lipstick like that?”), ignoring the female's comment, or turning the hoop around (e.g., Female—“will you buy me a drink?” Male—“buy me a drink and we'll see”). If the male is able to get the female to jump through one of his hoops, he may then jump through one of hers without the loss of attraction.

During A3, the male may also wish to engage in some role reversal, conveying to the woman that she wants the male, that she is chasing the male, that the male is the one with higher value, that the male is the one who will decide if he wants to continue with the female, and that the male is screening the female to make sure she qualifies for him. The male may accomplish this with one or more role-reversal lines, which express sentiments that would typically be expressed by the female in the same setting. The following are examples of role-reversal lines:

“Don't think you're going to get something just because your buying me this drink”

“Geez are you always this forward?”

“I don't want to rush things”

“I don't want to get hurt. I need lots of comfort and trust first.”

“I want to get to know you better first.”

“I don't do that on a first date.”

### Role-reversal lines help establish apparent disinterest, a lack of neediness, high standards, and an interest in the woman that transcends her looks.

To establish that the male is engaged in screening of the female, the male may wish to ask questions that are consistent with screening. Examples include:

“Is there more to you than meets the eye?”

“What do you want to be when you grow up?”

“What are some things about you that would make me want to get to know you better?”

“If you had to pick one thing that makes life worth living, what would it be?”

“So tell me, what are your three best qualities?”

“Are you a passionate person?”

The screening process should be implicit rather than explicit. Through the use of questions such as these, the female will realize that the male is screening her. That will indicate to her that the male has standards and is selective, and is a demonstration of higher value on his part.

As noted above, substep A3 is where the male gives IOI's to the target female. However, preferably, this should be done in an intermittent fashion, mixed in with IOD's. This creates a hot/cold, push/pull dynamic that is emotionally stimulating. It makes the female more likely to chase, and will make her want to comply with compliance tests that the male will give her during A3.

A3 is also an appropriate stage to begin the process of physical touching between the male and the target female, referred to herein as “kino” (for “kinesthetic”). Preferably, kino should begin in the early stages of the encounter, and should progressively escalate. Examples of kino may include walking arm in arm, hands touching, embracing, embracing from behind, kissing lips, kissing or nibbling on the neck, hand on knee, sitting on lap, arm around waist, touching face, smelling or pulling air, and hand on rear end. The male should be careful not to make a big deal out of kino, it should instead be a subtle, accelerating process as the energy grows between him and the target female.

Kino should be engaged in in a natural and confident manner, without excuses. On the other hand, there should be an intermittent quality to this process, with the male taking one step forward (escalation) followed by two steps back (de-escalation). The two steps back creates more discomfort on the part of the female, making her more likely to comply with future forward steps. The two steps back can be physical (tossing her hand away) or emotional, such as a turning of the body, a verbal IOD, and/or a neg.

During this process, the male preferably engages in compliance testing, which consists of providing the female with a kino-related hoop. Examples include: taking the females hand and dropping it, and seeing if she grabs for the male's hand again; squeezing the female's hand to see if she will squeeze back; putting the female's hand on the male's knee and seeing if she will leave it there; sitting the female on the male's lap; etc. If the female complies, the male can reward her with an IOI, followed by an IOD to create more sexual tension, and so on in an intermittent process. If the male does not receive compliance with the compliance test, he can respond with an IOD, followed by a DHV, an IOI, and then another compliance test. Figure [3] [147] is a diagram of the preferred compliance process. Use of proper sequencing can create a compliance momentum on the part of the female.

IOI's that the male will give to the female during the A3 may include statements of interest (“SOI's”). This is an explicit verbal statement of the male's growing interest in the female. Examples include:

“You know what, you are actually pretty cool, I'm curious about you”

“I have to hang out with you again sometime”

“When we met, you just seemed like another one of those California blondie girls, But since I get to know you, I actually feel nervous around you.”

Offering to buy the female a drink.

SOI's may also include complements. However, these should not be complements about the female's looks. Instead, it is preferable to complement the female's style, energy, poise, or something unique about the outfit that she chose. A complement can be followed by a screening question or a neg, to demonstrate value.

A metaphor for the process that is underway in A3 is bait, hook, reel, and release. Baiting occurs when the male gets the female to tell interesting things about herself. Her reply shows that she has been hooked. The male reels her in with an IOI, only to push her off again (release her form the pressure of being hit on) with an IOD, false time constraint, or neg.

Turning now to the comfort building step 14, it can be broken down into substeps C1 (conversation), C2 (connection), and C3 (intimacy). The three sub-steps of the comfort building step will occur in three different locations—C1 may occur within the meeting location, in a different portion thereof or in a separate location entirely, C2 should occur in a different location from the meeting location, and C3 will occur at a location that is within the sex location. Each of these substeps will be described, in turn.

Referring first to substep C1, this is the step at which the male establishes with the target female a conversational rapport, a sense of comfort and trust, a sense that this interaction is real and genuine, and a feeling of connection. The location of the comfort building substep is generally an important part of success during this phase. The location within the meeting location where the male and female first met is not necessarily suitable. The music may be too loud, it may be too crowded, and too many other people (e.g., friends, former boyfriend, family members, etc.) may be around to allow a suitable connection to be created. The comfort location should be quiet and secluded, though typically still public, and should be a place where the male and target female can engage in lengthy dialogue.

There are generally three possible physical locations for C1. These may be a quiet location within the meeting location, a suitable location separate from both the meeting location and the sex location, and a comfort location within the sex location. In the first alternative, the C1 location may be a quiet area of a club or coffee shop, or near a wall or bar. Movement within the meeting location to a quiet location suitable for the C1 step is called a “bounce” (shown as “B” on FIG. 2). Physically moving to a separate location entirely is called a “move” (shown as “M” on FIG. 2). Generally, a bounce will be easier to execute than a move, since it carries less safety risk for a female who has just met the male. Prior to A1, the male should identify suitable possible locations for C1. Where the male and female move to a separate location for C1, this process in itself can be a powerful comfort builder.

To convince the female to move or bounce, the male needs to isolate her from other members of the set. He may need to use an isolation line that will accomplish this, such as:

“Let's go get a drink”

“I'm going to show you something really neat, come with me”

“[Spoken to the other members of the set] Is it okay if I borrow your friend for a second?”

During C1, the male will want to be talkative, without explicitly trying to impress or show off. He will want to avoid weird, creepy or foolish topics, and favor ones that are fun, interesting and emotionally compelling. He will want to demonstrate vulnerability and establish commonality and connection. Establishing commonality will help to make the female feel that the relationship was meant to be, and will help her be able to visualize the male as a realistic addition to her everyday life. Vulnerability can be established through stories that are embarrassing, sad, that reveal an insecurity or a secret—without coming across as whiny over overly sensitive. In telling about himself, he will want to tell his back story step by step, providing grounding for his reality. The male will want to use canned material. He will generally be agreeable.

During C1, the male will escalate kino and use compliance testing. The male may wish to play games with the female, to establish a conspiracy between them. For example, he may involve her in a people-watching game about other people within the location.

During C1, the female may occasionally test the male with negative behavior, such as an IOD. The male will want to respond, during this substep, in a slightly different manner than earlier in the process. Instead of using a neg, the male will want to give a slight IOD, perhaps as subtle as stopping talking for a moment, or turning slightly away, to communicate a slight disinterest. This will cause the female to again want to express interest. At this point, male can structure a compliance test, the female will comply, and the male will reward the female with a positive comment.

During C2, the male will be seeking to have the female feel familiar with him. It can involve shared space at the mall, keeping each other company, talking on the phone, changing locations, etc. During C2, the male will want to engage in kino and kissing with the female, though in a manner calculated to increase comfort, and not as seduction. Preferably, the male will need to spend between four and ten hours, and preferably about seven hours, from the beginning of the process until engaging in sexual intercourse with the female. Much of this time is spent during the comfort building phase, including particularly C2. It should be noted that the accumulation of seven hours of time with the female may occur over several days or even weeks.

While C1 prefers occurs within a relatively quiet location within the original meeting location, C2 should occur in a location that is separate from the meeting location (and also from the sex location). Before the male first approaches a target female in the meeting location, he should have a C2 location already picked out. Examples include a bar, coffee shop or quiet restaurant; window shopping; or a walk from one comfort building location to another.

The process of moving from the C1 location to the C2 location may be referred to as “jumping.” Jumping can occur in one of two forms—a bounce or a time bridge (shown as “T” in FIG. 2). A bounce occurs when the male and female move from the C1 to the C2 location in the same evening. The time-bridge occurs when the male makes plans to see the female at another time—at a definite time and place where the male and female will again be together in person to continue the courtship. Jumping is a powerful comfort builder in and of itself.

An additional jump occurs from the C2 location to the C3 location. For C3, the male and female will be at a location that is within the sex location. Examples of C3 locations include a couch in the male's living room, a Jacuzzi a short distance from the male's bedroom or hotel room, or sitting on a couch in the lobby near the male's hotel room. As with the C2 location, the male should choose a suitable C3 location in advance of first meeting the target female at the meeting location.

The sex location itself, where S1-S3 will occur, should be marked primarily by its privacy and close proximity to the C3 comfort building location. Examples include the male's hotel room, the male's bedroom, or the female's bedroom. Because the C3 and S1 locations are in close proximity—in fact, they are both within the same larger location (e.g., hotel lobby and hotel room; living room and bedroom of same apartment, etc.), the male and female can move quickly and easily from the C3 to the S1 location.

At S1, the progression toward sex intensifies, with the male and female engaging in sexual foreplay. After S1, and before S3 (sexual intercourse), there may be an S2, which is where a female may express last minute resistance to the idea of sexual intercourse with the male. There are different techniques for the male to ease the female through S2. The male may express his own token resistance (“We should stop”), may persist following a slight tactical retreat, may freeze out the female in a manner that communicates to the male that he is unaffected by her resistance to the idea of sex and that it is no big deal, or may just go to sleep.

Preferably, the methods as herein described are taught to males in a variety of forms, including seminars, workshops, consultations, books, DVD's, etc. In the course of such teaching, the three main stages, and the nine substeps, may be explained and demonstrated as necessary to students, so that they may then practice these methods in a real world environment.

While the invention has been particularly shown and described with reference to the preferred embodiments thereof, it will be understood by those skilled in the art that the foregoing and other changes in form and details may be made therein without departing from the spirit and scope of the invention.

I claim:

1. An interpersonal pursuit method for a male pursuing an intimate relationship with a female, comprising:
instructing a male regarding an interpersonal pursuit method comprising instructing the male how to:
build attraction on the part of a target female;
establish comfort with the target female; and
promptly after conclusion of the step of establishing comfort, seducing the target female and having sexual intercourse with her;
wherein the steps of building attraction, establishing comfort, and seducing last between four and ten hours;
wherein the step of building attraction occurs at a first location, wherein the step of establishing comfort begins at the first location and continues to a second and than a third location, and wherein the step of seducing the target female occurs at the third location.

2. The method of claim 1 wherein the steps of building attraction, establishing comfort, and seducing last approximately seven hours.

3. The method of claim 1 wherein the step of building attraction comprises the following sub-steps:
opening a set and continuing until reaching a social hook point;
establishing female to male interest; and
establishing male to female interest.

4. The method of claim 1 wherein the step of building comfort comprises the following sub-steps:
the male engaging in conversation with the target female;
the male establishing a connection with the target female; and
the male beginning intimate relations with the target female.

5. The method of claim 1 wherein the step of the male seducing the target female comprises the following sub-steps:
the male and the target female engaging in foreplay;
the male overcoming last minute resistance on the part of the target female to sexual intercourse; and
the male and target female engaging in sexual intercourse.

6. The method of claim 3 wherein the male is instructed to open the set within approximately three seconds of spotting the set.

7. The method of claim 3 wherein during the step of opening the set and continuing until reaching a social hook point, the male is instructed to use at least one of negs, disinterested body language, a false time constraint, and entry to the set with another female.

8. The method of claim 3 wherein during the step of opening the set and continuing until reaching a social hook point, the male is instructed to use canned material that conveys at least one of personality and value to the target female.

9. The method of claim 3 wherein during the step of establishing female to male interest, the male is instructed to utilize multiple conversational threads.

10. The method of claim 3 wherein during the step of establishing female to male interest, the male is instructed to utilize a lock-in prop.

11. The method of claim 3 wherein during the step of establishing male to female interest, the male is instructed to engage in at least one of role reversal and screening.

12. The method of claim 3 wherein during the step of establishing male to female interest, the male is instructed to intermittently provide to the target female indicators of interest and indicators of disinterest.

13. The method of claim 3 wherein during the step of establishing male to female interest, the male is instructed to begin the process of physical touching of the target female and to progressively escalate physical touching.

14. The method of claim 3 wherein during the step of establishing male to female interest, the male is instructed to engage in compliance testing of the target female.

15. The method of claim 14 wherein during the step of establishing male to female interest, the male is instructed to reward compliance with an indicator of interest, followed by an indicator of disinterest.

16. The method of claim 14 wherein during the step of establishing male to female interest, the male is instructed to respond to non-compliance with an indicator of disinterest, followed by a demonstration of higher value, followed by an indicator of interest, followed by another compliance test.

17. The method of claim 4 wherein for the substep of the male engaging in conversation with the target female, the male will be instructed to jump to a different location utilizing one of a bounce and a time-bridge.

18. The method of claim 4 wherein the male will be instructed to change physical locations following the step of the male establishing a connection with the target female.

19. An interpersonal pursuit method for a male pursuing an intimate relationship with a female, comprising:
instructing a male regarding an interpersonal pursuit method comprising instructing the male how to:
build attraction on the part of a target female;
wherein the step of building attraction comprises the following sub-steps:
opening a set and continuing until reaching a social hook point;
establishing female to male interest; and
establishing male to female interest;
establish comfort with the target female;
wherein the step of building comfort comprises the following sub-steps:
the male engaging in conversation with the target female;
the male establishing a connection with the target female; and
the male beginning intimate relations with the target female; and
promptly after conclusion of the step of establishing comfort, seducing the target female and having sexual intercourse with her;
wherein the step of the male seducing the target female comprises the following sub-steps:
the male and the target female engaging in foreplay;
the male overcoming last minute resistance on the part of the target female to sexual intercourse; and
the male and target female engaging in sexual intercourse;
wherein the steps of building attraction, establishing comfort, and seducing last between four and ten hours;
wherein the step of building attraction occurs at a first location, wherein the step of establishing comfort begins at the first location and continues to a second and than a third location, and wherein the step of seducing the target female occurs at the third location.

20. An interpersonal pursuit method for a male pursuing an intimate relationship with a female, comprising:
instructing a male regarding an interpersonal pursuit method comprising instructing the male how to:
build attraction on the part of a target female;
wherein the step of building attraction comprises the following sub-steps:
opening a set and continuing until reaching a social hook point;
including instructing the male to use at least one of negs, disinterested body language, a false time constraint, and entry to the set with another female;
establishing female to male interest;
including instructing the male to utilize multiple conversational threads; and
establishing male to female interest;
including instructing the male to engage in at least one of role reversal, screening, intermittent provision of indicators of interest and indicators of disinterest, and compliance testing;
establish comfort with the target female;
wherein the step of building comfort comprises the following sub-steps:
the male engaging in conversation with the target female;
the male establishing a connection with the target female; and
the male beginning intimate relations with the target female; and
promptly after conclusion of the step of establishing comfort, seducing the target female and having sexual intercourse with her;
wherein the step of the male seducing the target female comprises the following sub-steps:
the male and the target female engaging in foreplay;
the male overcoming last minute resistance on the part of the target female to sexual intercourse; and
the male and target female engaging in sexual intercourse;
wherein the steps of building attraction, establishing comfort, and seducing last between four and ten hours;
wherein the step of building attraction occurs at a first location, wherein the step of establishing comfort begins at the first location and continues to a second and than a third location, and wherein the step of seducing the target female occurs at the third location.
